(19) United States
(12) Patent Application Publication
(10) Pub. No.: US 2003/0009005 A1
(43) Pub. Date: Jan. 9, 2003

(54) Acetoacetylated diamines and polyamines

(76) Inventors: Uta Glufke, Basel (CH); Paul Hanselmann, Brig-Glis (CH)

Correspondence Address: Fisher Christen & Sabol, Suite 1108, 1725 K Street NW, Washington, DC, 20006, US

(21) Appl. No.: 10/204,440

(22) PCT Filed: Mar. 1, 2001
(86) PCT No.: PCT/EP01/02309

(30) Foreign Application Priority Data
Mar. 2, 2000 (EP) 00104335.5

(51) Int. Cl. C08G 69/08

(52) U.S. Cl. 528/310

(57) ABSTRACT

The invention relates to novel acetoacetylated diamines and polyamines and to a method for the production thereof. The acetoacetylated diamines and polyamines are compounds of formula (I), wherein R¹ and R², independent of one another, represent hydrogen or C₁₋₆ alkyl, and A represents C₃₋₈ cycloalkanediyl or a group of formula (II): —(CR³R⁴)ₚ—[NR—(CR⁵R⁶)_{q}]ᵣ.

The present invention relates to novel acetoacetylated diamines and polyamines and to a process for their preparation.

The reaction of primary aliphatic diamines of the formula NH₂—(CH₂)ₙ—NH₂ with diketene to give N,N′-bis-(acetoacetyl)polymethylenediamines is described in the following literature: Iwakura, Y.; Nagakuba, K.; Matsuga, Y.; Liu, F-C. Chemical Abstracts 1956, 4008. Beger, J.; Thielemann, C. J. Prakt. Chem., 1981, 323, 2, 337-344.

The cited literature contains no reference to the reaction of cycloalkanediamines, aliphatic diamines with branched alkylene groups, or aliphatic polyamines.

It was the object of the present invention to provide novel acetoacetylated diamines and polyamines.

In accordance with the invention, this object is achieved by diamines and polyamines according to claim 1.

The novel compounds have the general formula

CH₃—CO—CH₂—CO—NR¹-A-NR²—CO—CH₂—CO—CH₃ (I)

in which

R¹ and R² independently of one another denote hydrogen or C₁₋₆-alkyl and

A denotes C₃₋₈-cycloalkanediyl or a group of the formula

—(CR³R⁴)ₚ—[NR—(CR⁵R⁶)_{q}]ᵣ (II)

in which

R is acetoacetyl;

R³, R⁴, R⁵ and R⁶ at each occurrence are identical or different and independently of one another denote hydrogen, C₁₋₆-alkyl or —(CH₂)ₙ—NRR⁷;

R⁷ denotes hydrogen or C₁₋₆-alkyl;

p denotes an integer from 2-21;

q at each occurrence is identical or different and in each case denotes integers from 2-21;

r denotes an integer from 0-6;

n at each occurrence is identical or different and denotes in each case integers from 1-6;

with the proviso that for r=0 at least one of the radicals R³ or R⁴ denotes C₁₋₆-alkyl or —(CH₂)ₙ—NRR⁷.

The radicals R¹ and R² are preferably hydrogen.

By C₁₋₆-alkyl here and below are meant all linear or branched alkyl groups having 1-6 carbon atoms, such as, for example, methyl, ethyl, propyl, isopropyl, butyl, isobutyl, sec-butyl, tert-butyl, pentyl, isopentyl, tert-pentyl, neopentyl, hexyl or isohexyl.

The expression “C₃₋₈-cycloalkanediyl” embraces, for example, cyclopropane-1,2-diyl, cyclobutane-1,2-diyl, cyclopentane-1,2-diyl, cyclopentane-1,3-diyl, cyclohexane-1,2-diyl, cyclohexane-1,3-diyl, cyclohexane-1,4-diyl, cycloheptane-1,2-diyl, cycloheptane-1,3-diyl, cycloheptane-1,4-diyl, cyclooctane-1,2-diyl, cyclooctane-1,3-diyl, cyclooctane-1,4-diyl. Preference is given to cyclohexane-1,2-diyl.

The expression “at each occurrence are identical or different and independently of one another denote hydrogen, C₁₋₆-alkyl or —(CH₂)ₙ—NRR⁷” embraces groups of the formula II where R³, R⁴, R⁵ and R⁶ either are identical at each occurrence and independently of one another denote hydrogen, C₁₋₆-alkyl or —(CH₂)ₙ—NRR⁷, preferably hydrogen, or do not have the same definition at each occurrence and independently of one another denote, one or more times, C₁₋₆-alkyl or —(CH₂)ₙ—NRR⁷ and the remaining times denote hydrogen.

Examples of groups of the formula II in which r=0 and R³ and R⁴ do not have the same definition at each occurrence and independently of one another denote, one or more times, C₁₋₆-alkyl and the remaining times denote hydrogen, are:

1-methylethane-1,2-diyl, 1-methylpropane-1,3-diyl, 1-ethylpropane-1,3-diyl, 1-methylbutane-1,4-diyl, 1-ethylbutane-1,4-diyl, 1-methylpentane-1,5-diyl, 1-ethylpentane-1,5-diyl, 1-propylpentane-1,5-diyl, 1-methylhexane-1,6-diyl, 1-ethylhexane-1,6-diyl, 1-propylhexane-1,6-diyl, 1-hexylundecane-1,11-diyl, 2-methylpropane-1,3-diyl, 2-methylbutane-1,4-diyl, 2-ethylbutane-1,4-diyl, 2-propylbutane-1,4-diyl, 2-methylpentane-1,5-diyl, 2-ethylpentane-1,5-diyl, 2-propylpentane-1,5-diyl, 2-methylhexane-1,6-diyl, 2-ethylhexane-1,6-diyl, 2-methylheptane-1,7-diyl, 1,1-dimethylethane-1,2-diyl, 1,2-dimethylpropane-1,3-diyl, 2,2-dimethylpropane-1,3-diyl, 1,2-dimethylbutane-1,4-diyl, 1,3-dimethylbutane-1,4-diyl, 1,5,9-trimethyldecane-1,10-diyl, 3-methylbutane-1,4-diyl, 3-methylpentane-1,5-diyl, 4-methylpentane-1,5-diyl, 3,3-dimethylbutane-1,4-diyl, 3-methylhexane-1,6-diyl, 4-methylhexane-1,6-diyl, 5-methylhexane-1,6-diyl, 3,5,5-trimethylhexane-1,6-diyl, 3,7-dimethyloctane-1,8-diyl and the like.

A group of the formula II in which r=0 and R³ and R⁴ do not have the same definition at each occurrence and independently of one another denote, one time, —(CH₂)ₙ—NRR⁷ and the remaining times denote hydrogen is, for example, 3-oxobutanoylaminomethyl.

The compounds of the formula I are obtained by reacting diketene with diamines or polyamines of the formula

R¹HN-A′-NHR² (III)

in which

R¹ and R² have the definition indicated above and

A′ denotes C₃₋₈-cycloalkanediyl or a group of the formula

—(CR⁸R⁹)ₚ—[NH—(CR¹⁰R¹¹)_{q}]ᵣ— (IV)

in which

p, q and r have the definition indicated above and

R⁸, R^{p}, R¹⁰ and R¹¹ at each occurrence are identical or different and independently of one another denote hydrogen, C₁₋₆-alkyl or —(CH₂)ₙ—NHR⁷;

n and R⁷ have the definition indicated above;

with the proviso that for r=0 at least one of the radicals R⁸ or R⁹ denotes C₁₋₆-alkyl or —(CH₂)ₙ—NHR⁷; the reaction being carried out such that one equivalent of diketene is used per amino, C₁₋₆-alkylamino or imino group.

Preferred diamines of the formula III are:

cyclohexane-1,2-diamine, pentane-1,3-diamine, 2-methylpentane-1,5-diamine, 4-(aminomethyl)octane-1,8-diamine, diethylenetriamine, dipropylenetriamine, dihexylenetriamine, dioctylenetriamine, N-(3-aminopropyl)-1,4-diaminobutane(spermidine), triethylenetetraamine, N,N′-bis(2-aminoethyl)-1,3-propanediamine.

The diamines of the formula III are obtainable commercially (e.g. 2-methylpentane-1,5-diamine or pentane-1,3-diamine) or may be prepared according to known methods e.g. by reacting 3-pentenenitrile with HCN and subsequent hydrogenation (2-methylpentane-1,5-diamine) or, respectively, by reacting 2-pentenenitrile with ammonia and subsequent hydrogenation (pentane-1,3-diamine).

The polyamines of the formula III are likewise available commercially (e.g. diethylenetriamine, dihexylenetriamine, dioctylenetriamine, spermidine, triethylenetetraamine) or may be prepared for example by reacting ethylenediamine with aziridine (->diethylenetriamine), by condensing the corresponding diamine in the presence of a catalyst (->dihexylenetriamine, dioctylenetriamine), or by treating 1,2-dichloroethane with ammonia (diethylenetriamine and triethylenetetraamine).

C₃₋₈-cycloalkanediamines are available commercially (e.g. cyclohexane-1,2-diamine) or may be prepared by reducing the corresponding dioxime and also by Curtius (or Hoffmann) degradation of the corresponding diacid azide (or, respectively, diamide).

The reaction of diamines or polyamines with diketene takes place at temperatures of from 0-150° C., preferably at 25-35° C.

Judiciously, the diamine or polyamine is dissolved in an appropriate solvent. The dissolved diamine or polyamine plus diketene are placed for example simultaneously into an initial solvent charge. Appropriate solvents are in particular:

water;

ketones e.g. acetone;

ethers, e.g. diethyl ether, 1,4-dioxane, tetrahydrofuran;

chlorinated aliphatic hydrocarbons, e.g. dichloromethane, 1,2-dichloroethane;

aromatic hydrocarbons, e.g. toluene and xylene.

The novel compounds are suitable as additives for binders which are used in the preparation of water-based and water-dilutable paints, varnishes and adhesives, and in solvent-based paints, varnishes and adhesives. The compounds of the formula I are stable to hydrolysis, serve to improve adhesion, and may also be used for postcrosslinking, for example, with polyamines, epoxides, isocyanates, hydrazines and other additives. Judiciously, 0.1-10% by weight of a compound of the formula I are added to the binder.

The following examples illustrate the implementation of the process of the invention, without there being any restriction to be seen therein.

### EXAMPLE 1

N-[2-Methyl-5-(3-oxobutyrylamino)pentyl]acetoacetamide

(I, R¹=R²=R⁴=H, R³=H and methyl, p=5, r=0, A=—CH₂—CH(CH₃)—(CH₂)₃—)

In a 5 l stirred vessel, 2200 ml of toluene were introduced and cooled to 2-8° C. 797.5 g (9.485 mol) of diketene and a solution of 550.0 g (4.733 mol) of 2-methyl-pentane-1,5-diamine in 2200 ml of toluene were added dropwise simultaneously over 6 hours at 20-30° C. A suspension was formed which was stirred at 30° C. for a further hour and then cooled to 15° C. The toluene phase (top phase) was removed by suction. The product phase (bottom phase) was admixed with 500 ml of dichloromethane, concentrated on a rotary evaporator and dried in vacuo (approximately 30 mbar) at 60° C. This gave 1297.9 g of N-[2-methyl-5-(3-oxo-butyrylamino)pentyl]acetoacetamide (90% yield, purity (titration): 93.1%) as a yellow viscous oil which gradually solidifies.

M.p.: 97.5° C.;

IR (KBr) 3276 (br s), 3091 (m), 2961 (m), 2931 (m), 2876 (m), 1719 (s), 1653 (s), 1558 (s), 1418 (m), 1331 (s), 1360 (m), 1163 (m) cm⁻¹;

¹H-NMR (400 MHz, DMSO-d₆) δ 14.15 (s, 0.2 H), 8.04-7.95 (m, 1.8 H), 7.82-7.79 (m, 0.2 H), 4.99 and 4.95 (s, 0.2 H), 3.30 and 2.98 (2×s, 3.8 H), 3.12-2.95 and 2.94-2.81 (2×m, 4H), 2.14 (s, 5.4 H), 1.80 (s, 0.6 H), 1.60-1.21 (m, 4 H), 1.16-1.02 (m, 1 H), 0.82 (d, J=8.2 Hz, 3 H);

¹³C-NMR (100 MHz, DMSO-d6, DEPT) δ 203.04, 203.02, 171.62, 171.45, 170.93, 165.95 and 165.78, 90.94 and 90.95, 51.29, 44.43, 43.78, 38.83 and 38.14, 32.58 and 32.48, 30.98, 29.84, 26.42 and 26.31, 20.82, 17.46;

GC-MS m/z: 285.

### EXAMPLE 2

N-[2-(3-Oxobutyrylamino)cyclohexyl]acetoacetamide

(I, R¹=R²=H, A=cyclohexane-1,2-diyl)

In a 5 l stirred vessel, 2300 ml of toluene were introduced and cooled to 2-8° C. 848.41 g (10.09 mol) of diketene and a solution of 575.0 g (5.0 mol) of cyclohexane-1,2-diamine in 2300 ml of toluene were added dropwise simultaneously over 3 hours at 20-30° C. A suspension was formed which was stirred at 30° C. for a further hour and then cooled to 15° C. The precipitate was filtered off with suction, washed with toluene (2×500 ml) and dried in vacuo (approximately 30 mbar) at 60° C. This gave 1232.29 g (84% yield) of N-[2-(3-oxobutyrylamino)-cyclohexyl]acetoacetamide (purity (titration): 96.4%) as a pale yellow solid.

M.p.: 147.7° C.;

IR (KBr) 3269 (s), 3077 (m), 2940 (m), 2861 (m), 1717 (s), 1635 (s), 1549 (s), 1418 (m), 1360 (m), 1343 (m) 1155 (m) cm⁻¹;

¹H-NMR (400 MHz, DMSO-d₆) δ 14.10 and 14.05 (2×s, 0.2 H), 7.92 and 7.70 (2×d, J=11.2 Hz, 2.0 H), 5.05 and 4.90 (2×s, 0.2 H), 3.98 and 3.55 (2×bs, 2.0 H), 3.30 and 3.22 (2×s, 3.8 H), 2.12, 2.10 and 2.05 (3×s, 5.5 H), 1.80 (s, 0.5 H), 1.83-1.10 (5×m, 8 H);

¹³C-NMR (100 MHz, DMSO-d₆, DEPT) δ 203.47, 202.76, 202.59, 171.21, 170.93, 170.90, 165.88, 165.78, 165.65 and 165.58, 91.35 and 91.15, 51.68, 51.64, 51.43, 51.32 and 51.01, 47.89, 31.92 and 31.84, 29.70, 29.61 and 29.14, 27.87, 24.24 and 21.68, 20.85 and 20.79;

GC-MS m/z: 283.

### EXAMPLE 3

N-[2-[(3-Oxobutyryl)-[2-(3-oxobutyrylamino)ethyl]-amino]ethyl]acetoacetamide

(I, R¹=R²=R³=R⁴=R⁵=R⁶=H, A=II, p=2, q=2, r=1).

In a 5 l stirred vessel, 2000 ml of toluene were introduced and cooled to 2-8° C. 1222.38 g (14.538 mol) of diketene and a solution of 500.0 g (4.846 mol) of diethylenetriamine in 2000 ml of toluene were added dropwise simultaneously over 2 hours at 30-40° C. A two-phase reaction mixture was formed which was stirred at 35° C. for a further hour and then cooled to 15° C. The toluene phase (top phase) was removed by suction. The product phase (bottom phase) was admixed with 500 ml of dichloromethane, concentrated on a rotary evaporator and dried in vacuo (approximately 30 mbar) at 60° C. This gave 1542.7 g (83% yield) of N-[2-[(3-oxobutyryl)-[2-(3-oxobutyrylamino)ethyl]-amino]ethyl]acetoacetamide(Purity (titration): 93.1%) as a yellow viscous oil.

IR (neat) 3309 (br s), 3079 (m), 2933 (m), 1720 (s), 1652 (br s), 1549 (s), 1479 (s), 1426 (s), 1361 (s), 1325 (s), 1162 (s) cm⁻¹;

¹-HNMR (400 MHz, DMSO-d₆) 14.87, 14.02 and 13.96 (3×s, 0.3 H), 8.21-8.16 and 8.12-8.04 (2×m, 2 H), 5.40, 4.96 and 4.91 (3×s, 0.3 H), 3.59 (s, 1.6 H), 3.403.10 (m, 12.1 H), 2.13 (s, 7.6 H), 1.90 and 1.79 (2×s, 1.4 H);

¹³C-NMR (100 MHz, DMSO-d₆, DEPT) δ 203.10, 202.85, 202.81, 174.24, 171.96, 171.70, 168.17, 167.34, 166.56, 166.17 and 166.03, 90.83, 90.65 and 87.22, 51.25, 51.17 and 51.04, 48.98, 48.70, 47.72, 47.17, 46.73, 46.66, 45.04, 44.53, 37.60, 37.49, 37.34, 36.78 and 36.45, 29.99, 29.95, 29.89, 29.85 and 29.81, 22.81, 21.50 and 20.79;

GC-MS m/z: 356.

### EXAMPLE 4

N-[6-[(3-Oxobutyryl)-[6-(3-oxobutyrylamino)hexyl]-amino]hexyl]acetoacetamide

(I, R¹=R²=R³=R⁴=R⁵=R⁶=H, A=II, p=q=6, r=1).

In a 5 l stirred vessel, 1250 ml of toluene were introduced and cooled to 2-8° C. 733.42 g (8.723 mol) of diketene and a solution of 625.0 g (2.902 mol) of dihexylenetriamine in 1250 ml of toluene were added dropwise simultaneously over 3 hours at 20-30° C. A two-phase reaction mixture was formed which was stirred at 30° C. for a further hour and then cooled to 15° C. The toluene phase (top phase) was removed by suction. The product phase (bottom phase) was admixed with 500 ml of dichloromethane, concentrated on a rotary evaporator and dried in vacuo (approximately 30 mbar) at 60° C. This gave 1305.8 g (87% yield) of N-[6-[(3-oxobutyryl)-[6-(3-oxobutyrylamino)hexyl]amino]hexyl]acetoacetamide (Purity (titration): 90.4%) as an orange viscous oil.

IR (neat) 3307 (br m), 2934 (m), 2860 (w), 1719 (m) 1645 (s), 1554 (m), 1434 (m), 1359 (m), 1321 (w), 1160 (w) cm⁻¹;

¹H-NMR (400 MHz, DMSO-d₆) δ 15.16 (s, 0.3 H), 8.02-7.96 (m, 1.8 H), 7.90-7.80 (m, 0.2 H), 5.25 and 4.91 (3×s, 0.3 H), 3.53 and 3.29 (2×s, 5.7 H), 3.30-3.11 and 3.09-2.99 (2×m, 8 H), 2.13 (s, 7.6 H), 1.90 and 1.80 (2×s, 1.4 H), 1.55-1.36 and 1.35-1.19 (2×m, 16 H);

¹³C-NMR (100 MHz, DMSO-d₆, DEPT) δ 203.06, 202.99, 174.10, 171.13, 166.30 and 165.74, 87.03, 51.28, 48.84, 47.54, 46.92, 44.98, 44.65, 38.45, 29.99, 29.85 and 29.82, 28.82, 28.36, 27.33, 27.05, 26.04, 26.00, 25.95, 25.74, 21.50;

GC-MS m/z: 468.

### EXAMPLE 5

N-[8-(3-oxobutanoylamino)-4-[(3-oxobutanoylamino)-methyl]octyl]acetoacetamide

(I, R¹=R²=R⁴H, R³=H and —(CH2)—NHR, R=acetoacetyl, p=8, r=0;

A=—(CH₂)₄—CH(CH₂NHCOCH₂COCH₃) —(CH₂)₃—)

In a 500 ml stirred vessel, 70 ml of toluene were introduced and cooled to 16° C. 36.42 g, (0.4332 mol) of diketene and a solution of 25.0 g (0.1443 mol) of 2-(4-aminobutyl-pentane-1,5-diamine in 70 ml of toluene were added dropwise simultaneously over 40 min at 20-30° C. A suspension was formed which was stirred at 30° C. for a further hour and then cooled to 15° C. The toluene phase (top phase) was removed by suction. The product phase was concentrated on a rotary evaporator and dried in vacuo (approximately 30 mbar) at 60° C. This gave 40.7 g (66% yield) of N-[8-(3-oxobutanoylamino)-4-[(3-oxobutanoylamino)methyl]octyl]acetoacetamide as a yellow honeylike substance.

IR (neat) 3303 (br m), 3087 (w), 2933 (m), 2864 (w) 1719 (s), 1649 8s), 1555 (s), 1417 (m), 1360 (m), 1325 (m), 1161 (m) cm⁻¹;

¹H-NMR (400 MHz, DMSO-d₆) δ 14.16 (s, 0.3 H), 8.01-7.96 and 7.95-7.89 (2×m, 2.7 H), 7.84-7.75 (m, 0.3 H), 4.99 and 4.90 (2×s, 0.3 H), 3.30 and 3.28 (2×s, 5.7 H), 3.11-2.98 (m, 6 H), 2.15 (s, 8.1 H), 1.80 (s, 0.9 H), 1.50-1.32 and 1.31-1.13 (2×m, 11 H);

¹³C-NMR (100 MHz, DMSO-d₆, DEPT) δ 203.03, 171.61, 171.45, 170.94, 166.05 and 165.81, 90.95, 51.31 and 51.29, 41.53, 38.93 and 38.48, 37.12, 30.72, 29.85, 29.83 and 29.80, 29.28, 28.30, 26.00 and 23.27, 20.81;

GC-MS m/z: 425.

1. Acetoacetylated diamines and polyamines of the formula
CH₃—CO—CH₂—CO—NR¹-A-NR²—CO—CH₂—CO—CH₃ (I)
in which
R¹ and R² independently of one another denote hydrogen or C₁₋₆-alkyl and
A denotes C₃₋₈-cycloalkanediyl or a group of the formula
—(CR³R⁴)ₚ—[NR—(CR⁵R⁶)_{q}]ᵣ (II)
in which
R is acetoacetyl;
R³, R⁴, R⁵ and R⁶ at each occurrence are identical or different and independently of one another denote hydrogen, C₁₋₆-alkyl or —(CH₂)ₙ—NRR⁷;
R⁷ denotes hydrogen or C₁₋₆-alkyl;
p denotes an integer from 2-21;
q at each occurrence is identical or different and in each case denotes integers from 2-21;
r denotes an integer from 0-6;
n at each occurrence is identical or different and denotes in each case integers from 1-6;
with the proviso that for r=0 at least one of the radicals R³ or R⁴ denotes C₁₋₆-alkyl or —(CH₂)ₙ—NRR⁷.

2. Compounds according to claim 1, in which R¹ and R² denote hydrogen.

3. Compounds according to claim 2, in which A denotes C₃₋₈-cycloalkanediyl, especially N-[2-(3-oxobutyrylamino)cyclohexyl]acetoacetamide.

4. Compounds according to claim 2, in which A denotes a group of the formula II with r=0, especially N-[2-methyl-5-(3-oxobutyryl-amino)pentyl]acetoacetamide or N-[8-(3-oxobutanoylamino)-4-[(3-oxobutanoylamino)methyl]octyl]acetoacetamide.

5. Compounds according to claim 2, in which A denotes a group of the formula II with r=1, especially N-[2-[(3-oxobutyryl)-[2-(3-oxobutyrylamino)ethyl]-amino]ethyl]acetoacetamide or N-[6-[(3-oxobutyryl)-[6-(3-oxobutyrylamino)hexyl]amino]hexyl]-acetoacetamide.

6. Process for preparing compounds of the formula I according to claim 1, characterized in that diketene is reacted with diamines or polyamines of the formula
R¹HN-A′-NHR² (III),
in which
R¹ and R² have the definition indicated above and A′ denotes C₃₋₈ cycloalkanediyl or a group of the formula
—(CR⁸R⁹)ₚ—[NH—(CR¹⁰R¹¹)_{q}[ᵣ— (IV)
in which
p, q and r have the definition indicated above and R⁸, R⁹, R¹⁰ and R¹¹ at each occurrence are identical or different and independently of one another denote hydrogen, C₁₋₆-alkyl or —(CH₂)ₙ—NHR⁷;
n and R⁷ have the definition indicated above;
with the proviso that for r=0 at least one of the radicals R⁸ or R⁹ denotes C₁₋₆-alkyl or —(CH₂)ₙ—NHR⁷;
the reaction being carried out such that one equivalent of diketene is used per amino, C₁₋₆-alkylamino or imino group.

7. Process according to claim 6, characterized in that a diamine of the formula III in which A′ denotes C₃₋₈-cycloalkanediyl or a group of formula IV with r=0 is reacted with two equivalents of diketene.

8. Process according to claim 6, characterized in that a diamine of the formula ITT in which A′ denotes a group of the formula IV with r=1 is reacted with three equivalents of diketene.

9. Process according to claim 6, characterized in that a diamine of the formula III in which A′ denotes a group of the formula IV with r=2 is reacted with four equivalents of diketene.

10. Process according to one of claims 6 to 9, characterized in that the reaction of diamines or polyamines of the formula III with diketene takes place at temperatures of from 0-150° C., preferably at 25-35° C.

11. Acetoacetylated diamines and polyamines obtainable by a process according to one of claims 6 to 10.

12. Use of the compounds of formula I according to claim 1 as additives for binders which are used in the preparation of water-based and water-dilutable paints, varnishes and adhesives, and in solvent-based paints, varnishes and adhesives.
